(19) United States
(12) Patent Application Publication
(10) Pub. No.: US 2026/0329688 A1
(43) Pub. Date: Oct. 22, 2026

(54) USING MACHINE LEARNING TO ALLOCATE AUXILIARY DATA COLLECTION RESOURCES

(71) Applicant: Dell Products L.P., Round Rock, TX (US)

(72) Inventors: Jeebak Mitra, Ottawa (CA); Avinash Kumar, PATNA, BIHAR (IN)

(21) Appl. No.: 19/181,228

(22) Filed: Apr. 16, 2025

(51) Int. Cl. G06F 11/07

(52) U.S. Cl. CPC G06F 11/0793; G06F 11/0709; G06F 11/079

(57) ABSTRACT

The technologies described herein are generally directed to using machine learning to allocate auxiliary data collection resources. For instance, a system can identify an anomaly in operation of a computing node of computing nodes of a network. The system may further identify, by employing a machine learning model, respective locations of telemetry information representative of operations of computing nodes that have dependencies upon the computing node, with the machine learning model being trained based on data representative of past anomalies in computing nodes of the network. Further, the system may, based on the telemetry information, identify and direct a network failure mitigation resource to perform a mitigation action to mitigate effects of the anomaly.

### BACKGROUND

Modern approaches to collecting auxiliary data across networks have evolved to handle increasingly diverse collections of network elements and available data. In some circumstances, as the amount of available data grows, the amount of less related and irrelevant data grows as well. In addition, while in some systems, the amount of auxiliary data available may grow exponentially, the processes used to collect and analyze generally do not. Notwithstanding the challenges associated with the use of auxiliary data, the importance of this data for achieving network security, performance, and service continuity goals will continue to increase.

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include identifying an anomaly in operation of a computing node of computing nodes of a network. The example method may further include identifying, by employing a machine learning model, respective locations of telemetry information representative of operations of dependent computing nodes of the computing nodes, different from the computing node, that have dependencies upon the computing node, with the machine learning model being trained based on data representative of past anomalies in computing nodes of the network. The example method may further include, based on the telemetry information, identifying and directing a network failure mitigation resource to perform a mitigation action to mitigate effects of the anomaly.

Additionally or alternatively, based on a degree of relationship to the anomaly, classifying the telemetry information, resulting in classified telemetry information, with the classified telemetry information including a classification. Additionally or alternatively, based on the classified telemetry information being determined to have a degree of relationship that exceeds a relevance threshold, retrieving, by the computing system, the classified telemetry information, resulting in retrieved telemetry information. Additionally or alternatively, based on respective classifications of the retrieved telemetry information, filtering, by the computing system, the retrieved telemetry information.

Additionally or alternatively, the classifying of the telemetry information includes, based on the respective classifications of the classified telemetry information, assigning a priority to the classified telemetry information. Additionally or alternatively, the retrieving of the classified telemetry information includes retrieving the classified telemetry information in an order based on respective priorities of the classified telemetry information. Additionally or alternatively, the filtering of the retrieved telemetry information is based further on respective priorities of the retrieved telemetry information. Additionally or alternatively, the telemetry information, the respective locations of which were identified based on the employing of the machine learning model, includes respective utility values representative of respective utilities of the classified telemetry information when employed to address the past anomalies, with the respective priorities being assigned to the classified telemetry information based on the respective utility values of the classified telemetry information. Additionally or alternatively, the utility values are updated dynamically based on the classified telemetry information, as anomalies are handled.

Additionally or alternatively, the method may further include identifying a result of the directing of the network failure mitigation resource to mitigate the effects of the anomaly. Additionally or alternatively, the method may further include updating the machine learning model based on training data representative of the result, and at least one of: the anomaly, the computing node, the dependent computing nodes, the respective locations of the telemetry information, the mitigation action, the network failure mitigation resource, or the effects of the anomaly. Additionally or alternatively, the employing of the machine learning model was based on a knowledge graph of relationships among entities including at least one of: communication links of the network, resource utilization links of resources of the network, the computing nodes, the respective locations of the telemetry information, resource utilization patterns, causal links applicable to past anomalies, the telemetry information, or the past anomalies.

Additionally or alternatively, the mitigation action and the network failure mitigation resource were selected using the machine learning model and based on the knowledge graph. Additionally or alternatively, the dependent computing nodes were identified based on the knowledge graph. Additionally or alternatively, the identifying of the respective locations of the telemetry information is based further on the knowledge graph. Additionally or alternatively, the telemetry data includes at least one of: event traces, crash logs, latency traces, or congestion metrics. Additionally or alternatively, the machine learning model was trained based further on data of the network representative of at least one of: operations of the computing nodes, user mobility, handover patterns, or load metrics.

Additionally or alternatively, the method may further include, based on telemetry information collected over time, dynamically determining, by employing the machine learning model, a predicted behavioral baseline for the computing node, with the identifying of the anomaly being based on a deviation from the predicted behavioral baseline.

An example system can operate as follows. At least one memory may store computer executable instructions, and at least one processor may be configured to process the computer executable instructions that, when executed by the at least one processor, facilitate performance of operations. The operations may include receiving an inquiry applicable to an event affecting computing devices of a wireless network. The operations may further include, based on the inquiry, sampling a data model that was trained based on historical data representative of past events that affected the wireless network, the sampling resulting in a prioritized list of auxiliary data records applicable to the event. The operations may further include communicating the prioritized list to a source of the inquiry.

Additionally or alternatively, the operations may further include, based on a dependency map of the computing devices of the wireless network, applying tags to the respective auxiliary data records, with the respective tags identifying, for the auxiliary data records, information representative of potential causes of the event. Additionally or alternatively, the operations may further include receiving, from the source, a model gradient applicable to update the data model, with the model gradient being generated based on an identified cause of the event and an action performed to resolve the event.

An example non-transitory machine-readable medium may include executable instructions that, when executed by at least one processor, facilitate performance of operations. The operations may include, based on a fault condition in a communications network, requesting a plan applicable to resolving the fault condition. The operations may further include, in response to the requesting, receiving the plan, with the plan including information representative of sources of metadata applicable to the event, collection priority values of the respective sources, and classifications of the respective sources. The operations may further include, based on the plan and a dependency map of entities of the communications network, performing a fault resolution action at an entity of the entities to eliminate the fault condition, with the plan being generated by a machine learning model that was trained based on metadata associated with communication via the communications network.

Additionally or alternatively, the operations may further include, based on a priority and a classification of a source of the sources, retrieving the metadata from the source, based on the metadata, identifying the entity and the fault resolution action, and based on an elimination of the fault condition by the fault resolution action, updating the machine learning model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using machine learning to allocate auxiliary data collection resources, in accordance with one or more embodiments;

FIG. 2 is an architecture diagram of an example system that can facilitate using machine learning to allocate auxiliary data collection resources, in accordance with one or more embodiments;

FIG. 3 is a flow diagram representing example operations of an example system that can facilitate using machine learning to allocate auxiliary data collection resources, in accordance with one or more embodiments;

FIG. 4 is a diagram that describes an example reinforcement learning process utilized by an example system to facilitate allocating auxiliary data collection resources, in accordance with one or more embodiments;

FIG. 5 includes a table that provides examples of how different processes employed by embodiments to allocate auxiliary data collection resources may handle different scenarios;

FIG. 6 includes tables that describe different related components of a knowledge graph that may be used to allocate auxiliary data collection resources, in accordance with one or more embodiments;

FIG. 7 includes tables that describe an example sequence of different operations and beneficial results therefrom that may be used to allocate auxiliary data collection resources, in accordance with one or more embodiments;

FIG. 8 depicts a flow diagram representing example operations of an example method that can facilitate using machine learning to allocate auxiliary data collection resources, in accordance with one or more embodiments;

FIG. 9 is a flow diagram representing operations of elements of an example system that can facilitate using machine learning to allocate auxiliary data collection resources, in accordance with one or more embodiments;

FIG. 10 depicts an example non-transitory machine-readable medium that can include executable instructions that, when executed by a processor of a system, can facilitate using machine learning to allocate auxiliary data collection resources, in accordance with one or more embodiments;

FIG. 11 is a schematic block diagram of a system with which the disclosed subject matter can interact; and

FIG. 12 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of systems that collect, analyze, and infer from auxiliary data to address network events can be improved, e.g., by providing approaches that employ machine learning to improve the processes that identify, tag, filter, prioritize, and retrieve auxiliary data in response to a system event/failure/anomaly. One or more embodiments described herein are not abstract concepts; rather, they provide technical solutions to technical problems associated with dynamically gathering and utilizing available data of diverse collections of network elements. Moreover, implementations described herein can provide these solutions in a manner that cannot reliably be performed by a human or even a plurality of humans, e.g., solutions provided are integral to the continuous monitoring and maintaining of complex networks.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

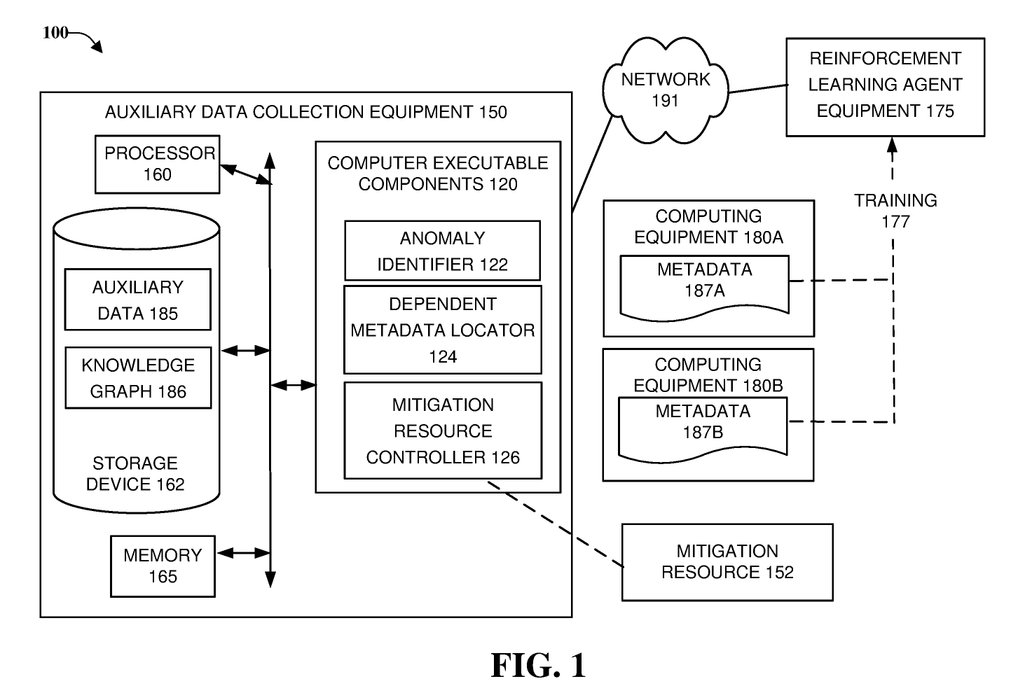

FIG. 1 is an architecture diagram of an example system 100 that can facilitate using machine learning to allocate auxiliary data collection resources, in accordance with one or more embodiments. For purposes of brevity, description of like elements and/or processes employed in other embodiments is omitted. As depicted, system 100 includes auxiliary data collection equipment 150 connected, via network 191, to reinforcement learning agent equipment 175. Computing equipment 180A-B is depicted as respectively having metadata 187A-B that is used for training 177 of a model (not shown) of reinforcement learning agent equipment 175. Auxiliary data collection equipment 150 is depicted as communicating with mitigation resource 152.

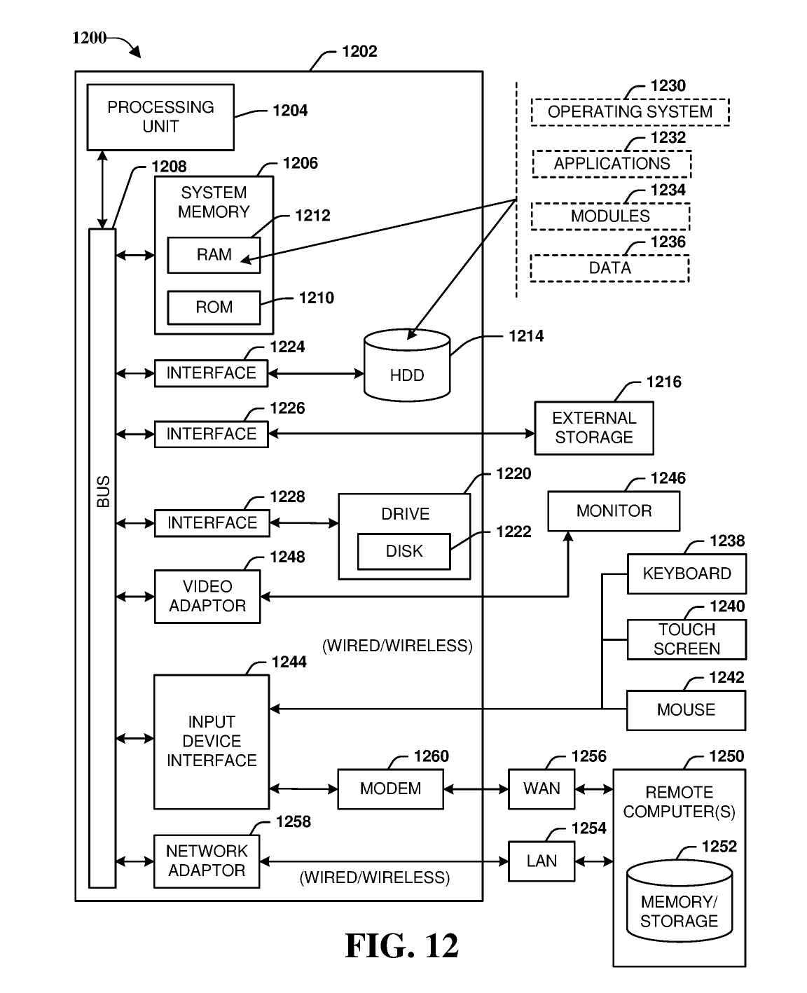

As discussed further with FIG. 12 below, network 191 can employ various wired and wireless networking technologies. For example, embodiments described herein can be exploited in substantially any wireless communication technology, comprising, but not limited to, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee, wireless fidelity (Wi-Fi), and other 802.XX wireless technologies and/or legacy telecommunication technologies.

As depicted, auxiliary data collection equipment 150 can include memory 165 that can store one or more computer and/or machine readable, writable, and/or executable components 120 and/or instructions. In embodiments, auxiliary data collection equipment 150 can further include processor 160. In one or more embodiments, computer executable components 120, when executed by processor 160, can facilitate performance of operations defined by the executable component(s) and/or instruction(s). Computer executable components 120 can include anomaly identifier 122, dependent metadata locator 124, mitigation resource controller 126, and other components described or suggested by different embodiments described herein, that can improve the operation of system 100. Auxiliary data collection equipment 150 may further include storage device 162. In an example, storage device 162 may provide nonvolatile storage of data, data structures, computer executable instructions, and so forth, e.g., auxiliary data 185 and knowledge graph 186.

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1204 of FIG. 12. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1206 and FIG. 12. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of anomaly identifier 122, which can in some implementations can identify an anomaly in operation of a computing node of computing nodes of a network. For example, in one or more embodiments, anomaly identifier 122 may identify an anomaly in the operation of computing equipment 180A of computing nodes of a network. In an embodiment, anomaly identifier 122 may identify the anomaly based on a deviation from a behavioral baseline for the computing node. In some implementations this behavioral baseline may be a predicted behavioral baseline that was predicted by employing a machine learning model and telemetry data of the computing nodes of the network.

In another example, memory 165 can store executable instructions that can facilitate generation of dependent metadata locator 124, which in some implementations may identify, by employing the machine learning model, respective locations of telemetry information representative of operations of computing nodes that have dependencies upon the computing node, with the machine learning model being trained based on data representative of past anomalies in computing nodes of the network. For example, in one or more embodiments, dependent metadata locator 124 can identify, by employing a machine learning model, that computing equipment 180B has dependencies (e.g., from knowledge graph 186) upon computing equipment 180A, and that metadata 187A has relevance (e.g., from knowledge graph 186) to the identified anomaly.

In another example, memory 165 can store executable instructions that can facilitate generation of mitigation resource controller 126, which in some implementations may, based on the telemetry information, identify and direct a network failure mitigation resource to perform a mitigation action to mitigate effects of the anomaly. For example, in one or more embodiments, mitigation resource controller 126 may, based on the retrieval of metadata 187A-B, identify mitigation resource 152 and direct mitigation resource 152 to perform a mitigation action at computing equipment 180A to mitigate effects of the anomaly.

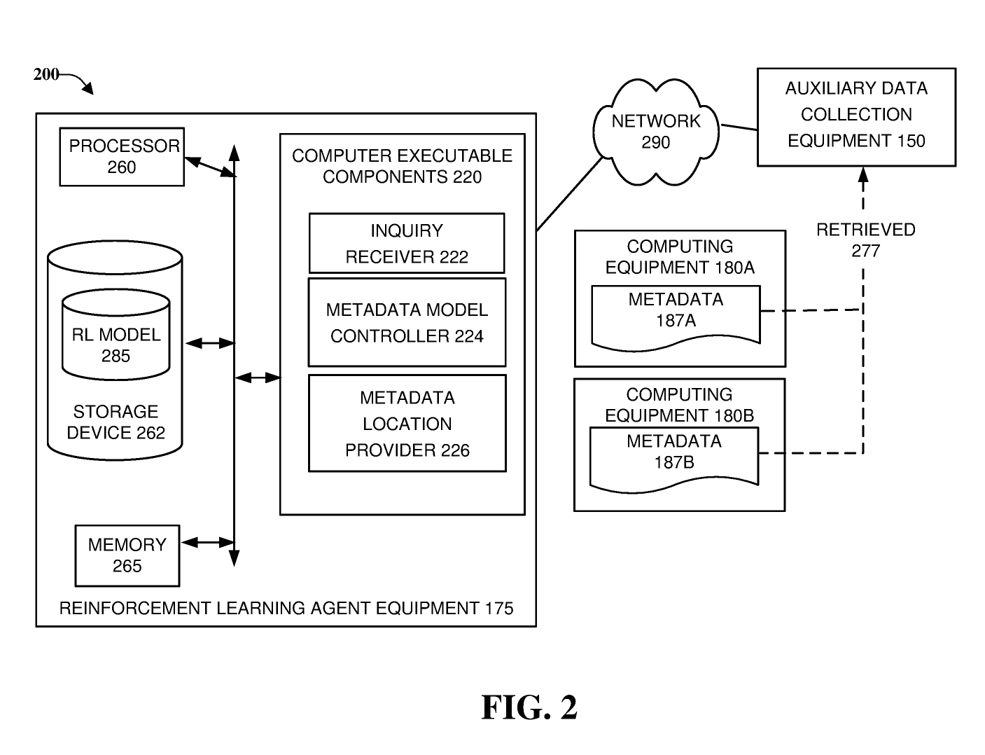

FIG. 2 is an architecture diagram of an example system 200 that can facilitate using machine learning to allocate auxiliary data collection resources, in accordance with one or more embodiments. For purposes of brevity, description of like elements and/or processes employed in other embodiments is omitted. As depicted, system 200 includes reinforcement learning agent equipment 175 connected, via network 290, to auxiliary data collection equipment 150. Computing equipment 180A-B is depicted as respectively having metadata 187A-B that is retrieved 277 by auxiliary data collection equipment 150.

Reinforcement learning agent equipment 175 includes processor 260, memory 265, storage device 262, and computer executable components 220. In an example, storage device 262 may provide nonvolatile storage of data, data structures, computer executable instructions, and so forth, e.g., reinforcement learning (RL) model 285. In embodiments, RL model 285 may be a deep reinforcement learning model that was trained based on historical data on average user mobility, handover patterns, network load metrics, and existing artificial intelligence algorithms. Implementing RL model 285 using a deep neural network (DNN) may facilitate the capture of complex input/output relationships between different network states, different network actions, and long-term rewards, e.g., by using a combination of weights and other model pertinent parameters to learn how specific sequences of actions may influence future outcomes in varied and uncertain conditions.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include inquiry receiver 222, metadata model controller 224, metadata location provider 226, and other components described or suggested by different embodiments described herein, e.g., that can improve the operation of system 200, in accordance with one or more embodiments.

As discussed further with FIG. 12 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of reinforcement learning agent equipment 175, memory 265 can store executable instructions that can facilitate generation of inquiry receiver 222, which in some implementations, may receive an inquiry applicable to an event affecting computing devices of a wireless network. For example, one or more embodiments, inquiry receiver 222 may receive an inquiry from auxiliary data collection equipment 150 regarding an anomaly occurring with computing equipment 180A.

In an example implementation of reinforcement learning agent equipment 175, memory 265 can further store executable instructions that can facilitate generation of metadata model controller 224, which in some implementations, may, based in the inquiry, sample a data model that was trained based on historical data representative of past events that affected the wireless network, the sampling resulting in a prioritized list of auxiliary data records applicable to the event. For example, in one or more embodiments, metadata model controller 224 may, based in the inquiry, sample RL model 285 that was trained based on historical data representative of past events computing equipment 180A-B, the sampling resulting in a prioritized list of auxiliary data records applicable to the event. In an example implementation of reinforcement learning agent equipment 175, memory 265 can further store executable instructions that can facilitate generation of metadata location provider 226, which in some implementations, may communicate the prioritized list to a source of the inquiry. For example, in one or more embodiments, metadata location provider 226 may communicate the locations of metadata 187A-B, along with priorities assigned thereto.

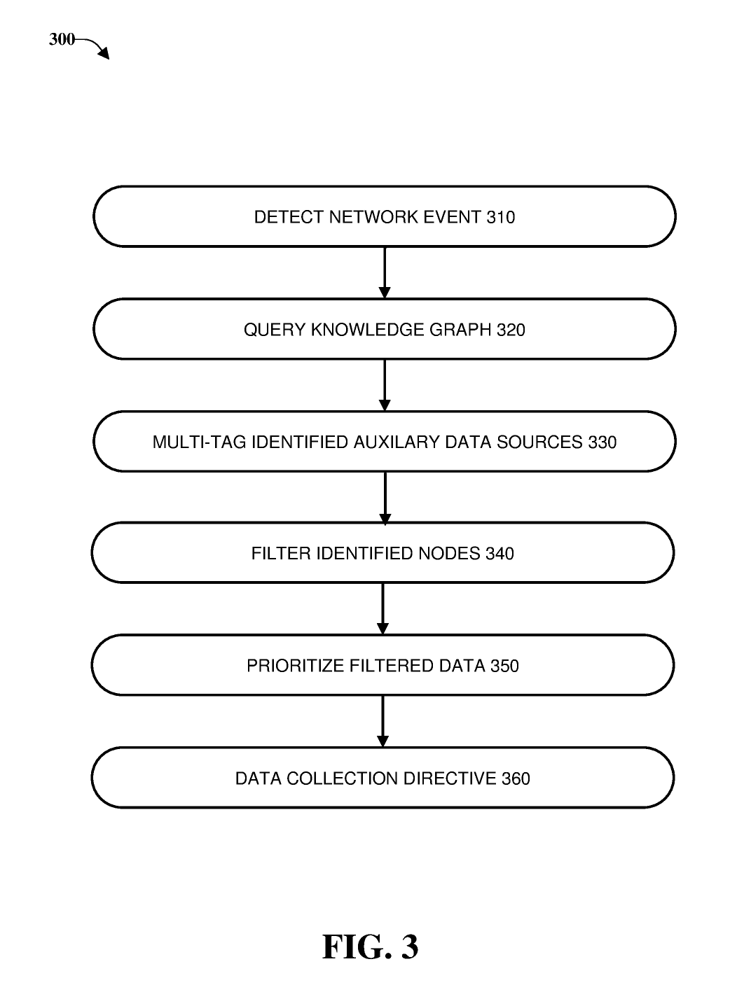

FIG. 3 is a flow diagram representing example operations of an example system 300 that can facilitate using machine learning to allocate auxiliary data collection resources, in accordance with one or more embodiments. For purposes of brevity, description of like elements and/or processes employed in other embodiments is omitted. System 300 includes an example flowchart sequence of operations that may be performed by one or more embodiments.

At 310, a network event is detected, e.g., an anomaly such as a base station failure reported by the fault detection system. At 320, a query of the knowledge graph is triggered based on the specifics of the network event. For example, embodiments may query the knowledge graph based on the base station subject to the event, neighboring base stations to the failed base station, telemetry such as network utilization logs from the implicated base stations.

In an embodiment, a knowledge graph may be a structured representation of information that organizes data into entities, relationships, and attributes to capture real-world knowledge. By connecting data points through nodes and edges, a knowledge graph may facilitate a more semantic and context-rich understanding of information. Furthermore, in the context of knowledge graphs, one or more embodiments may use ontologies to define and categorize the entities within the graph, thereby organizing them based on a taxonomy, or classification system. In some implementations, ontologies may incorporate multiple taxonomies, e.g., to facilitate provision of a flexible and comprehensive framework for defining complex relationships among network equipment. In some embodiments, knowledge graph 186 may describe relationships among network entities and relationships that include: communication links of the network, resource utilization links of resources of the network, the computing nodes, the respective locations of the telemetry information, resource utilization patterns, causal links applicable to past anomalies, the telemetry information, or the past anomalies.

Example direct dependencies of the knowledge graph employed by embodiments include, but are not limited to, logs and telemetry from a target base station, and event traces from base stations identified to be in a logical and/or geographic proximity to the target base station. Example indirect dependencies include, but are not limited to, core network nodes that handle traffic implicated by the triggering event and telemetry showing congestion in base stations identified to be in a logical and/or geographic proximity to the target base station. Example irrelevant data include, but are not limited to, logs from regions unaffected by the triggering event and/or the target base station and user equipment similarly unrelated to the triggering event and/or the target base station.

In an example knowledge graph, nodes may represent network elements, while edges represent dependencies. For example, base Stations may be included as nodes in the knowledge graph that represent the base station components, core network nodes may be included as nodes that represent the core nodes connecting base stations and user equipment, user equipment may be included as nodes of the knowledge graph that represent mobile devices or users affected by network conditions, data sources may be included as nodes of the knowledge graph that represent logs, event traces, telemetry data, and fault detection sources, causal links may be included as edges of the knowledge graph that represent fault propagation paths linking base stations to the core network and UE, when the base station is the module under test, resource utilization may be included as edges that represent links showing the effect of congestion on nodes connected to base stations, and communication links may be included as edges of the knowledge graph that represent dependencies between a base station and neighboring base stations.

A knowledge graph for a portion of the network handled by embodiments discussed herein may be queried in response to the triggering event of 310 related to the portion of the network. In an example implementation, anomaly identifier 122 may detect a network event. Based on this network event, knowledge graph 186 may be queried, and computing equipment 180A (e.g., a base station of the radio access network) may be identified as incurring a failure of some, or all base station functions.

At 330, a multi-tag process may be used to assign tags to the auxiliary data of the knowledge graph to denote dependencies, causal links, and resource utilization patterns. In addition, tags may be applied based on the relevance of respective metadata to various network metrics, e.g., security, throughput, latency, and fault diagnosis. In embodiments, each piece of auxiliary data (e.g., logs, traces) may be assigned multiple tags. For example, in a failure of computing equipment 180A, metadata 187A of computing equipment 180A (e.g., a log of activity), and metadata 187A of neighboring computing equipment 180B (e.g., a log of security events of computing equipment 180B) may both be identified as relevant to the failure event based on the query of the knowledge graph at 320. At 330, metadata 187A may be tagged with ‘fault diagnosis’ and ‘latency’ tags, and metadata 187B may be tagged with ‘related node’ and ‘security’ tags.

At 340, based on the tagging of 330, the identified nodes and dependencies may be filtered by embodiments to reduce the significance of unrelated and irrelevant nodes. In the example, third computing equipment (not shown), may have auxiliary data referenced by knowledge graph 186 that is implicated by the query triggered by the failure of computing equipment 180A. Because 330 assigned an ‘irrelevant’ (or similar) tag to this third metadata source, at 340, this metadata may be filtered out from continued analysis by embodiments.

At 350, based on the tagging of 330, relevant data identified by 340 may be prioritized based on usefulness for the determination and reconciliation of the network event. Example relevant auxiliary data for certain events include, but are not limited to, logs (e.g., crash logs and latency traces), event traces (e.g., handover failures between the failed base station and neighboring base stations), and telemetry (e.g., signal degradation and congestion metrics relate to the neighboring base stations).

Returning to the example, based on the tagging of 330, at 350, respective priorities may be assigned to the retrieval and analysis of metadata 187A-B by auxiliary data collection equipment 150. In this example, because metadata 187A was tagged with a ‘fault diagnosis’ tag, this metadata may be prioritized over retrieval of metadata 187B.

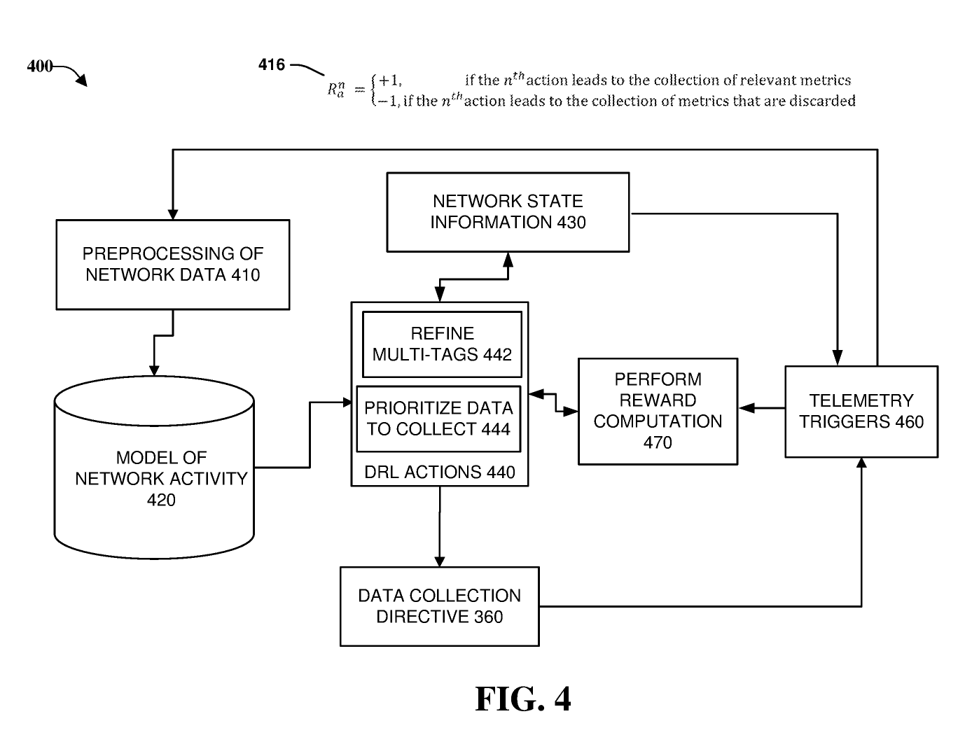

At 360, embodiments facilitate the collection of the identified relevant auxiliary data in accordance with the priorities assigned to the data. In the example, based on the assigned priorities of 350, metadata 187A is retrieved first and metadata 187B is retrieved second. After collection, analysis, and use of the auxiliary data to mitigate the triggering event, embodiments may use monitoring and deep reinforcement learning to refine the multi-tagging and prioritization processes previously described. Different refinement processes that may be employed by embodiments are discussed with FIG. 4 below.

FIG. 4 includes a diagram that illustrates aspects of example system 400 that can facilitate using machine learning to allocate auxiliary data collection resources, in accordance with one or more embodiments.

FIG. 4 is a diagram that describes an example reinforcement learning process utilized by an example system 400 to facilitate allocating auxiliary data collection resources, in accordance with one or more embodiments. For purposes of brevity, description of like elements and/or processes employed in other embodiments is omitted.

System 400 includes a flowchart of processes that may be performed after 310-360 described above to optimize/adjust the priority determinations, relevance determinations, and tagging performed thereby. Stated differently, one or more embodiments may iteratively refine data collection and tagging criteria to adapt to evolving network conditions. As described further below, embodiments may employ a deep reinforcement learning (DRL) agent to monitor network telemetry and historical data to improve the processes of auxiliary data collection, tagging, filtering, and prioritizing for collection. Broadly speaking, the DRL agent of embodiments may use network state information 430 (e.g., traffic load, fault events, past anomaly occurrences) to infer best actions to improve results, e.g., adjusting collection priorities, refining multi-tags, and/or changing filtering criteria.

An approach used by one or more embodiments may employ RL model 285 to review and adjust the results of the failure mitigation processes discussed above. As depicted in FIG. 4, at 410, over time, network data may be preprocessed to develop model of network activity 420 (e.g., similar to RL model 285). In an example, after mitigation actions are performed based on the collected auxiliary data, network state information may be analyzed to identify areas where 330, 340, and 350 may be potentially improved, e.g., characteristics of the telemetry/state information may trigger the updating processes described with 440 and 470 below.

At 470, a reward computation may be performed, e.g., by employing a reward function that was configured to weigh and compare the relevance of the collected auxiliary data and real-time analytics performance. In an example, model of network activity 420 may be used to guide DRL actions 440, thereby improving the accuracy of auxiliary data tagging at 442, and data prioritization at 444. In an example, formula 416 may be used to dynamically adjust the operation of embodiments based on direct feedback from network state information 430.

For example, if logs from a specific base station are consistently useful during failures, the priority of these logs may be increased. Embodiments may perform this optimization process over time with dynamically updated utility values, resulting in a continuous optimization of tagging strategies, e.g., reducing irrelevant data collection while enhancing anomaly detection capabilities. The action space can be limited or large depending on the amount of telemetry options offered within the designed system. Therefore rather than restrict the convergence for the DRL agent, the convergence of the DRL agent may be open and discrete, e.g., resulting in DRL improvements that can be effected through a soft actor-critic approach for a continuous action space.

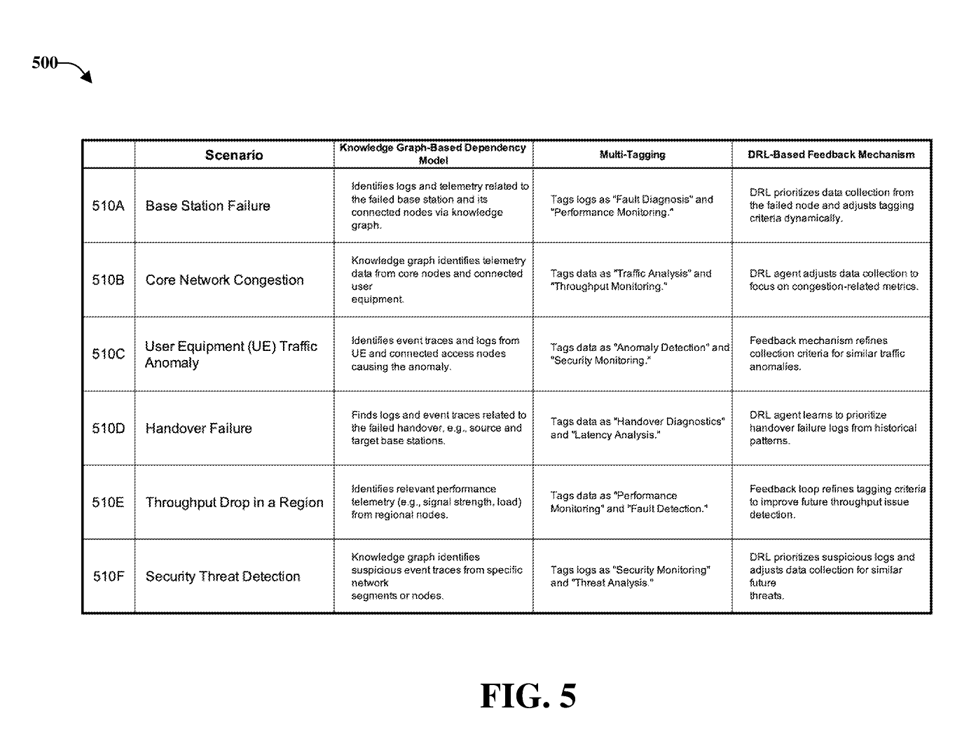

FIG. 5 includes a table that provides examples 500 of how different processes employed by embodiments to allocate auxiliary data collection resources may handle different scenarios. For purposes of brevity, description of like elements and/or processes employed in other embodiments is omitted. The examples include scenarios 510A-E.

Example scenario 510A describes an example base station failure. In an example, a knowledge graph may identify logs and telemetry related to the failed base station and its connected nodes. Embodiments may tag logs as “fault diagnosis data” and “performance monitoring data.” A deep reinforcement learning agent may be employed to prioritize data collection from the failed node and adjusts tagging criteria dynamically.

Example scenario 510B describes example core network congestion. In an example, a knowledge graph may identify telemetry data from core nodes and connected user equipment. Embodiments may tag data as “traffic analysis data” and “throughput monitoring data.” A deep reinforcement learning agent may be employed to adjust data collection to focus on congestion-related metrics.

Example scenario 510C describes an example UE traffic anomaly. In an example, a knowledge graph may identify event traces and logs from UE and connected access nodes causing the anomaly. Embodiments may tag data as “anomaly detection data” and “security monitoring data.” A deep reinforcement learning agent and a feedback loop may be employed to refine collection criteria for similar traffic anomalies.

Example scenario 510D describes an example handover failure. In an example, a knowledge graph finds logs and event traces related to the failed handover, e.g., source and target base stations. Embodiments may tag data as “handover diagnostics data” and “latency analysis data.” A deep reinforcement learning agent may be employed to prioritize handover failure logs from historical patterns.

Example scenario 510E describes an example throughput drop in a region. In an example, a knowledge graph may identify relevant performance telemetry (e.g., signal strength, load) from regional nodes. Embodiments may tag data as “performance monitoring data” and “fault detection data.” A deep reinforcement learning agent and a feedback loop may be employed to refine tagging criteria to improve future throughput issue detection.

Example scenario 510F describes an example security threat detection. In an example, a knowledge graph may identify suspicious event traces from specific network segments or nodes. Embodiments may tag logs as “security monitoring data” and “threat analysis data.” A deep reinforcement learning agent may be employed prioritize suspicious logs and adjust data collection for similar future threats.

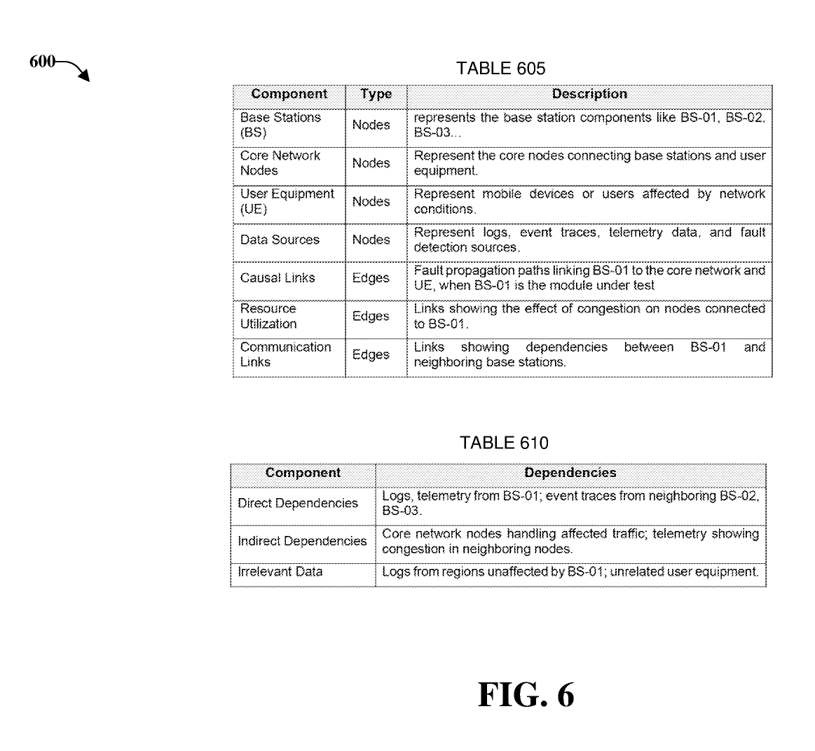

FIG. 6 includes an example 600 of tables 605 and 610 that describe different related components of a knowledge graph that may be used to allocate auxiliary data collection resources, in accordance with one or more embodiments. Table 605 provides a list of example component information that may be incorporated by embodiments into a knowledge graph. Table 610 provides a list of example types of dependencies along with example network components associated with the example types.

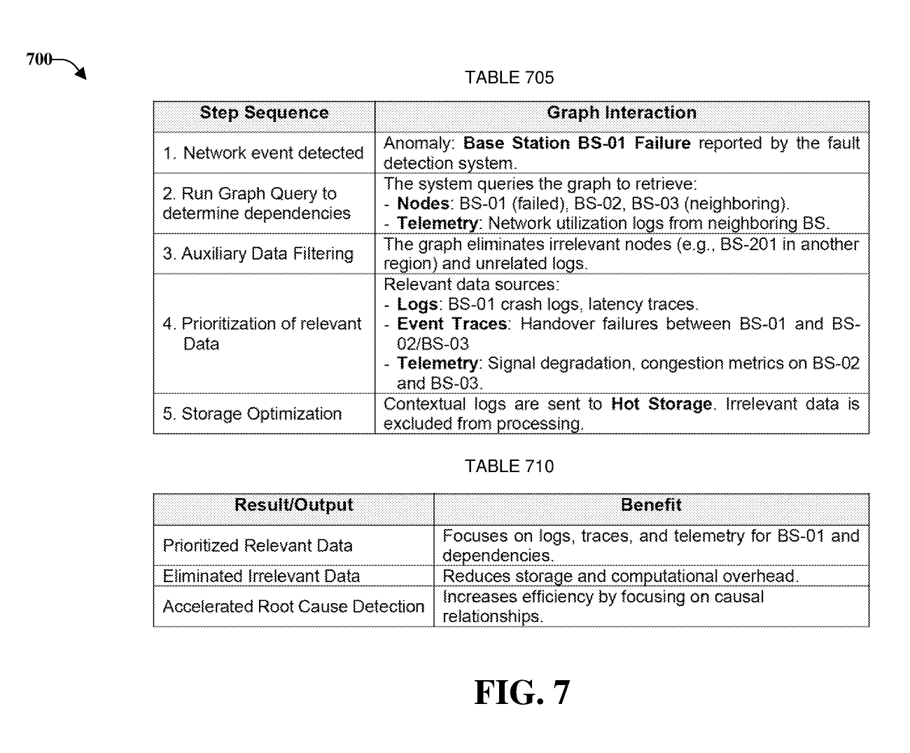

FIG. 7 includes an example 700 of tables 705 and 710 that describe an example sequence of different operations and beneficial results therefrom that may be used to allocate auxiliary data collection resources, in accordance with one or more embodiments. Table 705 provides a listing of sequence of operations that may be performed to implement a knowledge graph query used to handle an anomaly that includes a base station failure. Example benefits for the operations include how respective operations facilitate the filtering of auxiliary data. Table 710 includes a list of example benefits that may be achieved based on the use of a knowledge graph query during normal system polling or in response to a detected network event/anomaly, in accordance with one or more embodiments.

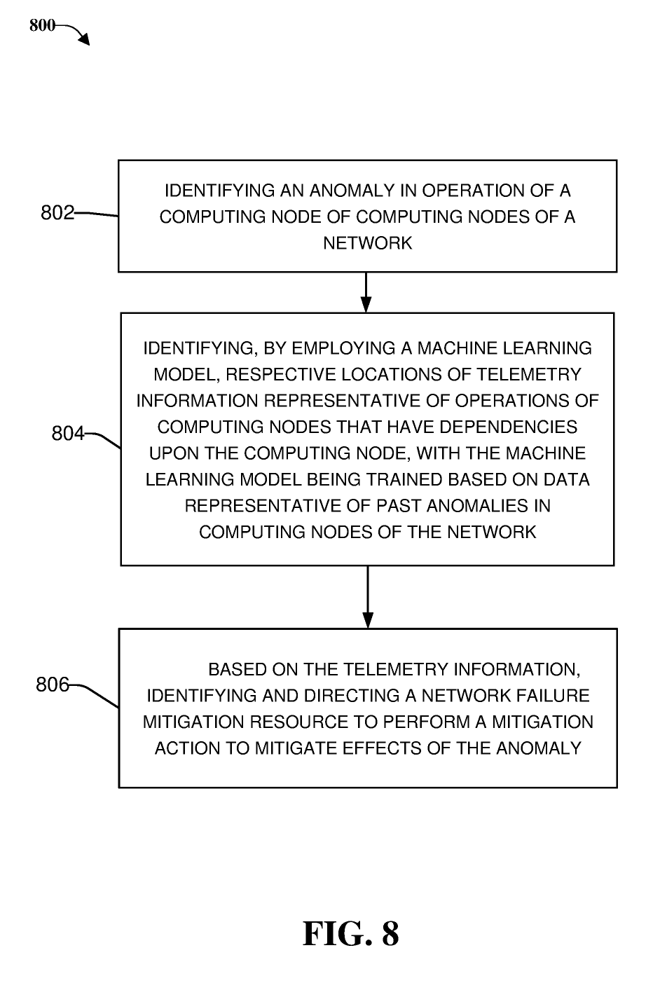

FIG. 8 depicts a flow diagram representing example operations of an example method 800 that can facilitate using machine learning to allocate auxiliary data collection resources, in accordance with one or more embodiments. For purposes of brevity, description of like elements and/or processes employed in other embodiments is omitted.

In some examples, one or more embodiments of method 800 can be implemented by anomaly identifier 122, dependent metadata locator 124, mitigation resource controller 126, and other components that can be used to implement aspects of method 800, in accordance with one or more embodiments. FIG. 8, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 802 of method 800, anomaly identifier 122 of auxiliary data collection equipment 150 can identify an anomaly in operation of a computing node of computing nodes of a network. At 804 of method 800, dependent metadata locator 124 can identify, by employing a machine learning model, respective locations of telemetry information representative of operations of computing nodes that have dependencies upon the computing node, with the machine learning model being trained based on data representative of past anomalies in computing nodes of the network. At 806 of method 800, mitigation resource controller 126 can, based on the telemetry information, identify and direct a network failure mitigation resource to perform a mitigation action to mitigate effects of the anomaly.

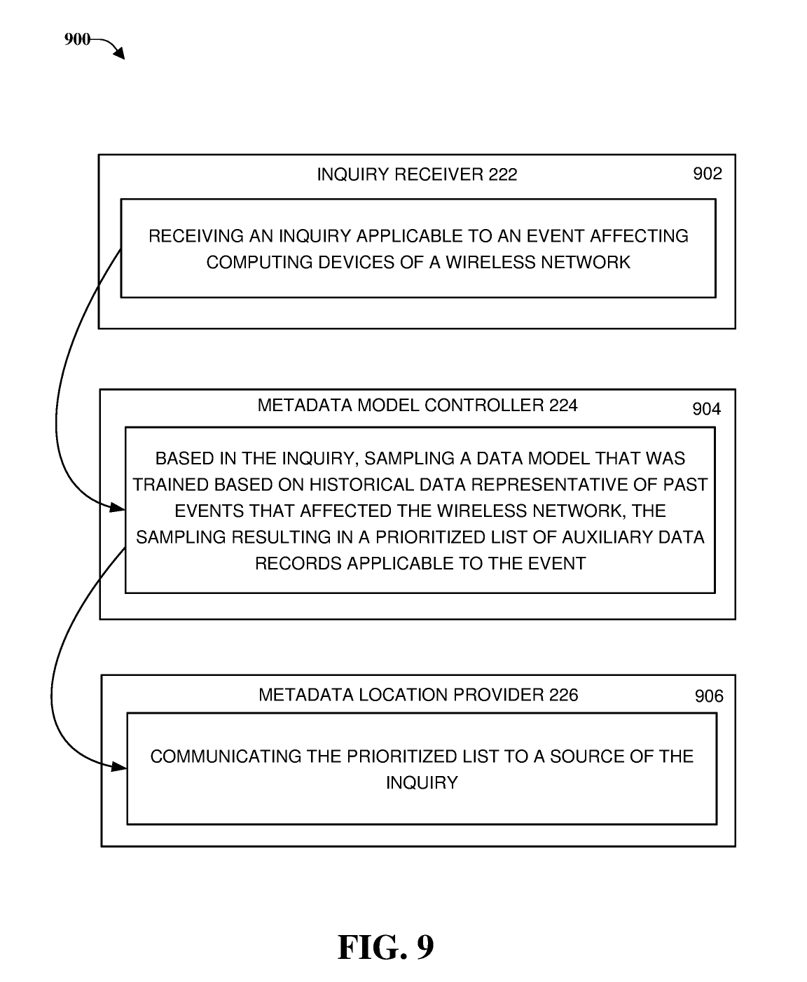

FIG. 9 is a flow diagram representing operations of elements of an example system 900 that can facilitate using machine learning to allocate auxiliary data collection resources, in accordance with one or more embodiments. For purposes of brevity, description of like elements and/or processes employed in other embodiments is omitted.

System 900 includes at least one memory that stores computer executable components, and at least one processor that executes the computer executable components stored in the at least one memory, with the computer executable components including inquiry receiver 222, metadata model controller 224, metadata location provider 226, and other components that can be used to implement aspects of system 900, as described herein, in accordance with one or more embodiments.

At 902 of FIG. 9, inquiry receiver 222 can receive an inquiry applicable to an event affecting computing devices of a wireless network. At 904 of FIG. 9, metadata model controller 224 can, based on the inquiry, sample a data model that was trained based on historical data representative of past events that affected the wireless network, the sampling resulting in a prioritized list of auxiliary data records applicable to the event. At 906 of FIG. 9, metadata location provider 226 can communicate the prioritized list to a source of the inquiry.

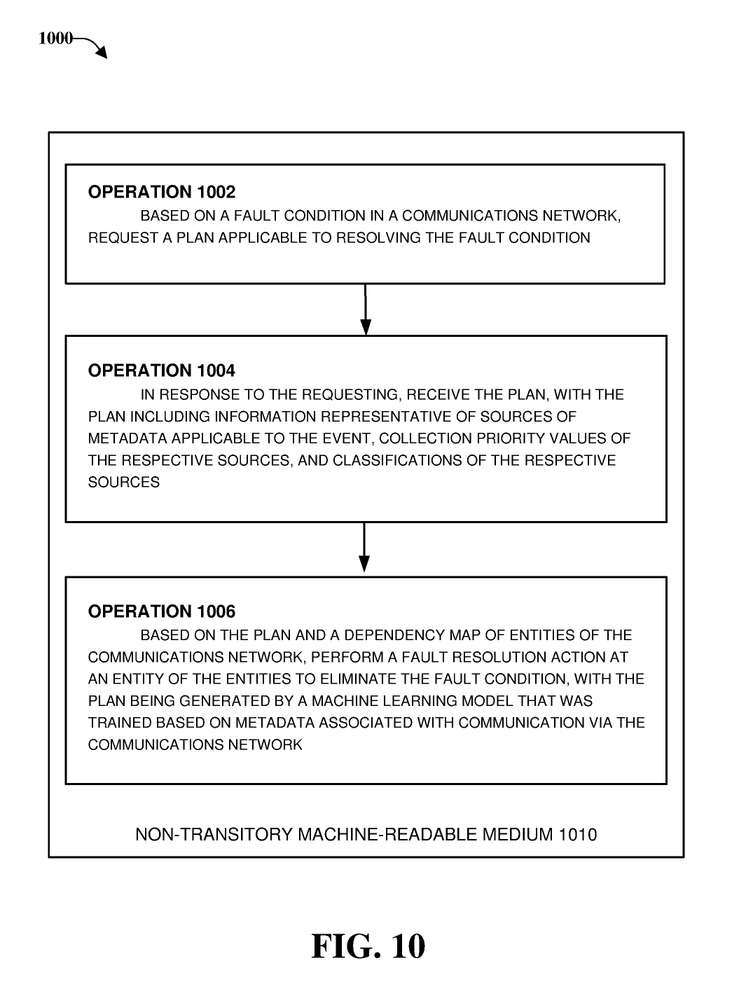

FIG. 10 depicts an example 1000 non-transitory machine-readable medium 1010 that can include executable instructions that, when executed by a processor of a system, can facilitate using machine learning to allocate auxiliary data collection resources, in accordance with one or more embodiments. For purposes of brevity, description of like elements and/or processes employed in other embodiments is omitted.

As depicted, non-transitory machine-readable medium 1010 includes executable instructions that, when executed by at least one processor of a machine learning device, facilitate performance of operations that include operation 1002 which can, based on a fault condition in a communications network, request a plan applicable to resolving the fault condition. The operations may further include operation 1004 which can, in response to the requesting, receive the plan, with the plan including information representative of sources of metadata applicable to the event, collection priority values of the respective sources, and classifications of the respective sources. The operations may further include operation 1006 which can, based on the plan and a dependency map of entities of the communications network, perform a fault resolution action at an entity of the entities to eliminate the fault condition, with the plan being generated by a machine learning model that was trained based on metadata associated with communication via the communications network.

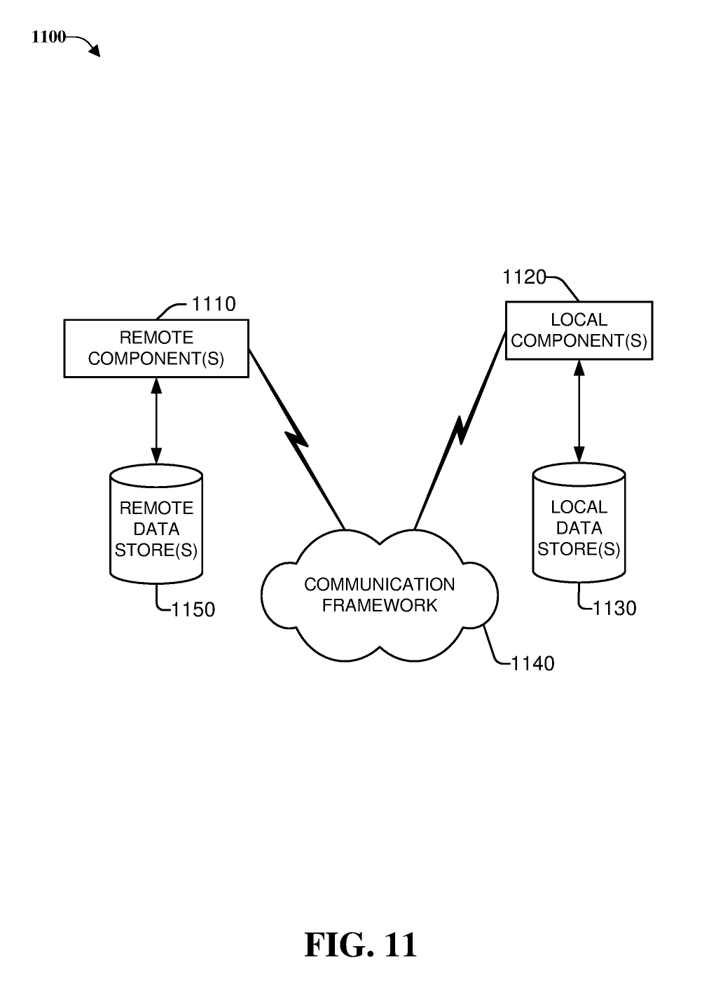

FIG. 11 is a schematic block diagram of a system 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, RAN devices, gateway devices, femtocell devices, servers, etc. The system 1100 also comprises one or more local component(s) 1120. The local component(s) 1120 can be hardware and/or software (e.g., threads, processes, computing devices).

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as "store," "storage," "data store," "data storage," "database," and substantially any other information storage component relevant to operation and functionality of a component, refer to "memory components," or entities embodied in a "memory" or components comprising the memory. It is noted that the memory components described herein can be either volatile memory or non-volatile memory, or can comprise both volatile and non-volatile memory, for example, by way of illustration, and not limitation, volatile memory 1220 (see below), non-volatile memory 1222 (see below), disk storage 1224 (see below), and memory storage, e.g., local data store(s) 1130 and remote data store(s) 1150, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some, if not all, aspects of the subject disclosure can be practiced on stand-alone computers. In a distributed computing environment, program modules can be located in different systems, e.g., both local and remote memory storage devices.

Referring now to FIG. 12, in order to provide additional context for various embodiments described herein, FIG. 12 and the following discussion are intended to provide a brief, general description of a suitable computing environment 1200 in which the various embodiments described herein can be implemented.

While the embodiments have been described above in the general context of computer executable instructions that can run on one or more computers, those skilled in the art will recognize that the embodiments can also be implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secure values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips…), optical discs (e.g., CD, DVD…), smart cards, and flash memory devices (e.g., card, stick, key drive…). Of course, those skilled in the art will recognize many modifications that can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer to determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service "execution" may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
identifying, by a computing system comprising at least one processor, an anomaly in operation of a computing node of computing nodes of a network;
identifying, by the computing system employing a machine learning model, respective locations of telemetry information representative of operations of dependent computing nodes of the computing nodes, different from the computing node, that have dependencies upon the computing node, wherein the machine learning model was trained based on data representative of past anomalies in computing nodes of the network; and
based on the telemetry information, identifying and directing, by the computing system, a network failure mitigation resource to perform a mitigation action to mitigate effects of the anomaly.

2. The method of claim 1, further comprising:
based on a degree of relationship to the anomaly, classifying, by the computing system, the telemetry information, resulting in classified telemetry information, wherein the classified telemetry information comprises a classification.

3. The method of claim 2, further comprising:
based on the classified telemetry information being determined to have a degree of relationship that exceeds a relevance threshold, retrieving, by the computing system, the classified telemetry information, resulting in retrieved telemetry information.

4. The method of claim 3, further comprising:
based on respective classifications of the retrieved telemetry information, filtering, by the computing system, the retrieved telemetry information.

5. The method of claim 4, wherein the classifying of the telemetry information comprises, based on the respective classifications of the classified telemetry information, assigning a priority to the classified telemetry information.

6. The method of claim 5, wherein the retrieving of the classified telemetry information comprises retrieving the classified telemetry information in an order based on respective priorities of the classified telemetry information.

7. The method of claim 5, wherein the filtering of the retrieved telemetry information is based further on respective priorities of the retrieved telemetry information.

8. The method of claim 5, wherein the telemetry information, the respective locations of which were identified based on the employing of the machine learning model, comprises respective utility values representative of respective utilities of the classified telemetry information when employed to address the past anomalies, wherein the utility values were dynamically updated based on the classified telemetry information and the past anomalies, and wherein respective priorities assigned to the classified telemetry information are based on the respective utility values of the classified telemetry information.

9. The method of claim 1, further comprising:
identifying, by the computing system, a result of the directing of the network failure mitigation resource to mitigate the effects of the anomaly; and
updating, by the computing system, the machine learning model based on training data representative of the result, and at least one of:
the anomaly,
the computing node,
the dependent computing nodes,
the respective locations of the telemetry information,
the mitigation action,
the network failure mitigation resource, or
the effects of the anomaly.

10. The method of claim 1, wherein the employing of the machine learning model was based on a knowledge graph of relationships among entities comprising at least one of:
communication links of the network,
resource utilization links of resources of the network,
the computing nodes,
the respective locations of the telemetry information,
resource utilization patterns,
causal links applicable to past anomalies,
the telemetry information, or
the past anomalies.

11. The method of claim 10, wherein the mitigation action and the network failure mitigation resource were selected using the machine learning model and based on the knowledge graph.

12. The method of claim 10, wherein the dependent computing nodes were identified based on the knowledge graph, and wherein the respective locations of the telemetry information is based further on the knowledge graph.

13. The method of claim 1, further comprising:
based on telemetry information collected over time, dynamically determining, by the computing system employing the machine learning model, a predicted behavioral baseline for the computing node, wherein the identifying of the anomaly comprises identifying the anomaly based on a deviation from the predicted behavioral baseline.

14. The method of claim 1, wherein the telemetry data comprises at least one of:
event traces,
crash logs,
latency traces, or
congestion metrics.

15. The method of claim 1, wherein the machine learning model was trained based further on data of the network representative of at least one of:
operations of the computing nodes,
user mobility,
handover patterns, or
load metrics.

16. A computing system, comprising:
at least one memory that stores computing executable instructions; and
at least one processor configured to process the computing executable instructions that, when executed by the at least one processor, facilitate performance of operations, comprising:
receiving an inquiry applicable to an event affecting computing devices of a wireless network,
based on the inquiry, sampling a data model that was trained based on historical data representative of past events that affected the wireless network, the sampling resulting in a prioritized list of auxiliary data records applicable to the event, and
communicating the prioritized list to a source of the inquiry.

17. The computing system of claim 16, wherein the operations further comprise:
based on a dependency map of the computing devices of the wireless network, applying tags to the respective auxiliary data records, wherein the respective tags identify, for the auxiliary data records, information representative of potential causes of the event.

18. The computing system of claim 16, wherein the operations further comprise:
receiving, from the source, a model gradient applicable to update the data model, wherein the model gradient was generated based on an identified cause of the event and an action performed to resolve the event.

19. A non-transitory machine-readable medium comprising executable instructions that, when executed by at least one processor of network controller equipment, facilitate performance of operations, the operations comprising:
based on a fault condition in a communications network, requesting a plan applicable to resolving the fault condition;
in response to the requesting, receiving the plan, wherein the plan comprises information representative of:
sources of metadata applicable to the event,
collection priority values of the respective sources, and
classifications of the respective sources; and
based on the plan and a dependency map of entities of the communications network, performing a fault resolution action at an entity of the entities to eliminate the fault condition, wherein the plan was generated by a machine learning model that was trained based on metadata associated with communication via the communications network.

20. The non-transitory machine-readable medium of claim 19, wherein the operations further comprise:
based on a priority and a classification of a source of the sources, retrieving the metadata from the source;
based on the metadata, identifying the entity and the fault resolution action; and
based on an elimination of the fault condition by the fault resolution action, updating the machine learning model.
